(19) United States
(12) Patent Application Publication
(10) Pub. No.: US 2023/0167881 A1
(43) Pub. Date: Jun. 1, 2023

(54) POWER TRANSMISSION UNIT

(71) Applicant: TOYOTA JIDOSHA KABUSHIKI KAISHA, Toyota-shi (JP)

(72) Inventors: Kensei HATA, Sunto-gun (JP); Hirotsugu YOSHINO, Numazu-shi (JP); Hiroyuki SHIBATA, Odawara-shi (JP)

(73) Assignee: TOYOTA JIDOSHA KABUSHIKI KAISHA, Toyota-shi (JP)

(21) Appl. No.: 17/977,271

(22) Filed: Oct. 31, 2022

(30) Foreign Application Priority Data
Nov. 30, 2021 (JP) 2021-194821

(51) Int. Cl. F16H 1/46

(52) U.S. Cl. CPC F16H 1/46; F16H 2200/2007; F16H 2200/2035

(57) ABSTRACT

A downsized power transmission unit having engagement devices. A first engagement device comprises a cylindrical first sleeve, and a second engagement device comprises a cylindrical second sleeve to which the first sleeve is inserted at least partially. First spline teeth and first dog teeth are formed on an inner circumferential surface of the first sleeve. Second spline teeth are formed on any one of an inner circumferential surface and an outer circumferential surface of the second sleeve, and second dog teeth are formed on the other one of the inner circumferential surface and the outer circumferential surface of the second sleeve.

### CROSS-REFERENCE TO RELATED APPLICATIONS

The present disclosure claims the benefit of Japanese Patent Application No. 2021-194821 filed on Nov. 30, 2021 with the Japanese Patent Office, the disclosures of which are incorporated herein by reference in its entirety.

### BACKGROUND

### Field of the Disclosure

Embodiments of the present disclosure relates to the art of a power transmission unit comprising a plurality of engagement devices manipulated to change a torque transmitting path.

### Discussion of the Related Art

JP-B2-6451524 describes a drive unit comprising: a first differential mechanism in which a first rotary element connected to an engine, a second rotary element connected to a first motor, and a third rotary element are connected to one another in a differential manner; a second differential mechanism in which a fourth rotary element connected to drive wheels, a fifth rotary element connected to the third rotary element, and a sixth rotary element are connected to one another in a differential manner; a first clutch device that selectively connects the first rotary element to the sixth rotary element; and a second clutch device that selectively connects the fifth rotary element to the sixth rotary element.

Given that dog clutches are employed as the clutch devices in the drive unit described in JP-B2-6451524 and that a first sleeve and a second sleeve of the clutch devices are arranged in the axial direction of the drive unit, an axial length of the power unit would be elongated to secure reciprocating spaces of the sleeves. Otherwise, given that one of the first and the second sleeves is inserted into an internal space of the other one the first and the second sleeves, the axial length of the drive unit would also be elongated depending on positions of splines for guiding the sleeves and dog teeth of the sleeves, and the other one the first and the second sleeves would be expanded in the radial direction.

### SUMMARY

Aspects of the present disclosure have been conceived noting the foregoing technical problems, and it is therefore an object of the present disclosure to prevent enlargement of a power transmission unit having a plurality of engagement devices.

According to the exemplary embodiment of the present disclosure, there is provided a power transmission unit, comprising: a first engagement device that selectively connects a predetermined pair of rotary members to each other; and a second engagement device that selectively connects another pair of rotary members to each other. In order to achieve the above-explained objective, according to the exemplary embodiment of the present disclosure, the first engagement device comprises a cylindrical first sleeve that reciprocates in an axial direction, and the second engagement device comprises a cylindrical second sleeve that reciprocates in the axial direction. Specifically, the first sleeve is inserted into the second sleeve at least partially. In the power transmission unit, first spline teeth engaged with any one of the predetermined pair of rotary members and first dog teeth engaged with the other one of the predetermined pair of rotary members are formed on an inner circumferential surface of the first sleeve. In addition, second spline teeth engaged with any one of said another pair of rotary members are formed on any one of an inner circumferential surface and an outer circumferential surface of the second sleeve, and second dog teeth engaged with the other one of said another pair of rotary members are formed on the other one of the inner circumferential surface and the outer circumferential surface of the second sleeve.

In a non-limiting embodiment, the predetermined pair of rotary members may include a first rotary member and a second rotary member, and said another pair of rotary members may include the first rotary member and a third rotary member.

In a non-limiting embodiment, a first engagement section may be formed on an outer circumferential surface of the first rotary member to be engaged with the second spline teeth or the second dog teeth. In addition, a cylindrical shaft may extend on radially inner side of the first engagement section, and a second engagement section may be formed on the cylindrical shaft to be engaged with the first spline teeth or the first dog teeth.

In a non-limiting embodiment, the power transmission unit may further comprise a first differential mechanism in which a first rotary element, a second rotary element, and a third rotary element are connected to one another in a differential manner. In addition, said another pair of rotary members may include: any one of the first rotary element, the second rotary element, and the third rotary element; and another one of the first rotary element, the second rotary element, and the third rotary element.

In a non-limiting embodiment, the first differential mechanism may comprise a sun gear, a ring gear, and a carrier. In addition, said another one of the first rotary element, the second rotary element, and the third rotary element may include the carrier.

In a non-limiting embodiment, the power transmission unit may further comprise a second differential mechanism in which a fourth rotary element, a fifth rotary element, and a sixth rotary element are connected to one another in a differential manner. In addition, the predetermined pair of rotary members may include: any one of the fourth rotary element, the fifth rotary element, and the sixth rotary element; and said another one of the first rotary element, the second rotary element, and the third rotary element.

In a non-limiting embodiment, the carrier may comprise a pair of carrier plates opposed to each other in the axial direction, and a third engagement section may be formed on an outer circumferential surface of one of the carrier plates to be engaged with the second spline teeth or the second dog teeth. In addition, a cylindrical shaft may extend on radially inner side of the third engagement section, and a fourth engagement section may be formed on the cylindrical shaft to be engaged with the first spline teeth or the first dog teeth.

In a non-limiting embodiment, an inner diameter of the cylindrical shaft may be larger than an outer diameter of the second differential mechanism, and the second differential mechanism may be arranged inside the cylindrical shaft. In addition, the fourth engagement section is formed coaxially with the second differential mechanism.

Thus, in the power transmission unit according to the exemplary embodiment of the present disclosure, the first sleeve is inserted into the second sleeve at least partially. As described, the first spline teeth engaged with any one of the predetermined pair of rotary members and the first dog teeth engaged with the other one of the predetermined pair of rotary members are formed on an inner circumferential surface of the first sleeve. In addition, the second spline teeth engaged with any one of said another pair of rotary members are formed on any one of an inner circumferential surface and an outer circumferential surface of the second sleeve, and the second dog teeth engaged with the other one of said another pair of rotary members are formed on the other one of the inner circumferential surface and the outer circumferential surface of the second sleeve. That is, the second spline teeth and the second dog teeth overlap with each other in the axial direction of the second sleeve. According to the exemplary embodiment of the present disclosure, therefore, an axial length of the second sleeve may be shortened. In addition, the first spline teeth and the first dog teeth are formed in tandem on the inner circumferential surface of the first sleeve. According to the exemplary embodiment of the present disclosure, therefore, an outer diameter of the first sleeve will not be increased. In other words, the outer diameter of the first sleeve can be reduced so that an outer diameter of the second sleeve will not be increased. Thus, not only the axial length but also the outer diameter of the power transmission unit can be reduced.

### BRIEF DESCRIPTION OF THE DRAWINGS

Features, aspects, and advantages of exemplary embodiments of the present disclosure will become better understood with reference to the following description and accompanying drawings, which should not limit the disclosure in any way.

FIG. 1 is a skeleton diagram showing one example of the power transmission unit according to the exemplary embodiment of the present disclosure; and

FIG. 2 is a skeleton diagram showing another example of the power transmission unit according to the exemplary embodiment of the present disclosure.

### DETAILED DESCRIPTION OF THE PREFERRED EMBODIMENT(S)

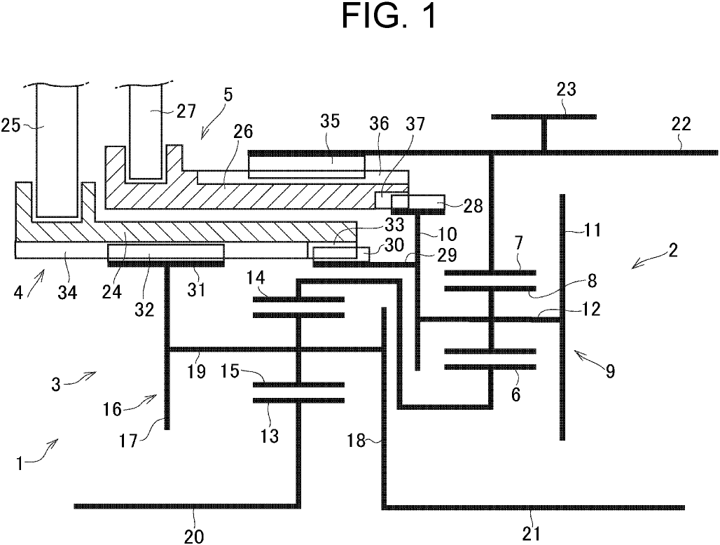

Preferred embodiments of the present disclosure will now be explained with reference to the accompanying drawings. Referring now to FIG. 1, there is shown one example of a structure of a power transmission unit 1 according to the present disclosure. As illustrated in FIG. 1, the power transmission unit 1 comprises a front planetary gear unit 2 as a first differential mechanism; a rear planetary gear unit 3 as a second differential mechanism; a first clutch 4 as a first engagement device; and a second clutch 5 as a second engagement device. In FIG. 1, a front section of the power transmission unit 1 is situated in the right side of FIG. 1.

In the power transmission unit 1 shown in FIG. 1, the front planetary gear unit 2 and the rear planetary gear unit 3 are arranged in tandem along a predetermined axis. The front planetary gear unit 2 comprises: a first sun gear 6 arranged around a predetermined axis; a first ring gear 7 as an internal gear arranged concentrically around the first sun gear 6; a plurality of first pinion gears 8 interposed between the first sun gear 6 and the first ring gear 7 while meshing with those gears; and a first carrier 9 supporting the first pinion gears 8 in a rotatable manner. Thus, the front planetary gear unit 2 preforms a differential action among three rotary elements such as the first sun gear 6 as a first rotary element, the first ring gear 7 as a second rotary element, and the first carrier 9 as a third rotary element. The first carrier 9 comprises a pair of annular carrier plates opposed to each other in an axial direction such as a rear carrier plate 10 and a front carrier plate 11, and a pinion pin 12 extending between the carrier plates 10 and 11.

On the other hand, the rear planetary gear unit 3 comprises: a second sun gear 13 arranged around a predetermined axis; a second ring gear 14 as an internal gear arranged concentrically around the second sun gear 13; a plurality of second pinion gears 15 interposed between the second sun gear 13 and the second ring gear 14 while meshing with those gears; and a second carrier 16 supporting the second pinion gears 15 in a rotatable manner. Thus, the rear planetary gear unit 3 also performs a differential action among three rotary elements such as the second sun gear 13 as a fourth rotary element, the second ring gear 14 as a fifth rotary element, and the second carrier 16 as a sixth rotary element. The second carrier 16 comprises a pair of annular carrier plates opposed to each other in an axial direction such as a rear carrier plate 17 and a front carrier plate 18, and a pinion pin 19 extending between the carrier plates 17 and 18.

The second sun gear 13 is joined to a sun gear shaft 20 extending toward the rear section in FIG. 1, and an inner circumference of the front carrier plate 18 closer to the front planetary gear unit 2 is joined to a carrier shaft 21 extending toward the front section in FIG. 1.

As illustrated in FIG. 1, the first sun gear 6 is diametrically larger than the second sun gear 13, and joined to the second ring gear 14. Likewise, the first ring gear 7 is diametrically larger than the second ring gear 14, and a cylindrical shaft 22 is joined to an outer circumference of the first ring gear 7. Specifically, an inner diameter of the cylindrical shaft 22 is larger than an outer diameter of the rear carrier plate 10 closer to the rear planetary gear unit 3, and the cylindrical shaft 22 extends to a radially outer side of the rear planetary gear unit 3. In addition, outer teeth 23 are formed on an outer circumferential surface of the cylindrical shaft 22. The first sun gear 6 has a hollow structure, and the carrier shaft 21 penetrates through a hollow portion of the first sun gear 6.

In the example shown in FIG. 1, the first carrier 9 is selectively connected to the second carrier 16 through the first clutch 4. According to the exemplary embodiment of the present disclosure, a dog clutch is adopted as the first clutch 4. The first clutch 4 comprises a cylindrical first sleeve 24, and a first shift fork 25. Specifically, the first shift fork 25 is engaged with a rear end of the first sleeve 24 from radially outer side so that an axial load established by an actuator (not shown) is transmitted from the first shift fork 25 to the first sleeve 24. That is, the first sleeve 24 is reciprocated in the axial direction by the axial load established by the actuator together with the first shift fork 25. Accordingly, in the exemplary embodiment of the present disclosure, the first carrier 9 also serves as a first rotary member, the second carrier 16 also serves as a second rotary member, and a pair of the first carrier 9 and the second carrier 16 serves as a predetermined pair of rotary members.

The first carrier 9 is also selectively connected to the first ring gear 7 through the second clutch 5. As the first clutch 4, a dog clutch is adopted as the second clutch 5. The second clutch 5 comprises a cylindrical second sleeve 26, and a second shift fork 27. Specifically, the second shift fork 27 is engaged with a rear end of the second sleeve 26 from radially outer side so that an axial load established by the actuator (not shown) is transmitted from the second shift fork 27 to the second sleeve 26. That is, the second sleeve 26 is reciprocated in the axial direction by the axial load established by the actuator together with the second shift fork 27. Accordingly, in the exemplary embodiment of the present disclosure, the first ring gear 7 also serves as a third rotary member, and a pair of the first carrier 9 and the first ring gear 7 serves as another pair of rotary members.

The second sleeve 26 is diametrically larger than the first sleeve 24 so that a front section of the first sleeve 24 is inserted into a hollow portion of the second sleeve 26. The rear end of the first sleeve 24 protrudes from a rear end of the second sleeve 26 so that the first shift fork 25 is allowed to be engaged with the rear end of the first sleeve 24 from radially outer side.

As illustrated in FIG. 1, dog teeth 28 are formed on an outer circumferential surface of the rear carrier plate 10 of the first carrier 9 while being spaced at predetermined intervals in the circumferential direction. In addition, a cylindrical shaft 29 that is diametrically larger than the second ring gear 14 of the rear planetary gear unit 3 is formed integrally with the rear carrier plate 10. Specifically, the cylindrical shaft 29 protrudes from the rear carrier plate 10 at a radially inner side of the dog teeth 28 toward the rear planetary gear unit 3, and dog teeth 30 are formed on an outer circumferential surface of the cylindrical shaft 29 while being spaced at predetermined intervals in the circumferential direction. That is, the dog teeth 30 are formed coaxially with the rotary elements of the rear planetary gear unit 3. In the exemplary embodiment of the present disclosure, the dog teeth 28 serve as a first engagement section and a third engagement section, and the dog teeth 30 serve as a second engagement section and a fourth engagement section.

A cylindrical shaft 31 is formed integrally with an outer circumferential surface of the rear carrier plate 17 of the second carrier 16. Specifically, an outer diameter of the cylindrical shaft 31 is substantially identical to an outer diameter of the cylindrical shaft 29, and spline teeth 32 having predetermined lengths in the axial direction are formed on an outer circumferential surface of the cylindrical shaft 31.

An inner diameter of the first sleeve 24 is slightly larger than the outer diameter of the cylindrical shaft 31. In the first sleeve 24, dog teeth 33 as first dog teeth are formed on a leading end to be engaged with the dog teeth 30, and spline teeth 34 as first spline teeth are formed between rear ends of the dog teeth 33 and the rear end to be engaged with the spline teeth 32. Thus, the first sleeve 24 is always rotated integrally with the second carrier 16, and allowed to reciprocate in the axial direction relatively to the second carrier 16. That is, when the first sleeve 24 moves toward the front planetary gear unit 2 so that the dog teeth 33 is engaged with the dog teeth 30, the second carrier 16 is connected to the first carrier 9 through the first sleeve 24.

Specifically, the dog teeth 33 and the spline teeth 34 are in phase with each other so that grooves of the dog teeth 33 and grooves of the dog teeth 34 are communicated with each other. Therefore, after positioning the front planetary gear unit 2 and the rear planetary gear unit 3, the first sleeve 24 is allowed to be engaged with the power transmission unit 1 by moving the first sleeve 24 toward the front planetary gear unit 2 while letting the dog teeth 33 through the spline teeth 32 to be engaged with the dog teeth 30.

As described, the cylindrical shaft 22 formed integrally with the first ring gear 7 extends toward the rear planetary gear unit 3, and the inner diameter of the cylindrical shaft 22 is larger than the outer diameters of the second sleeve 26 and the second ring gear 14. That is, the rear planetary gear unit 3 is held inside of the cylindrical shaft 22. Spline teeth 35 having predetermined lengths in the axial direction are formed on an inner circumferential surface of the cylindrical shaft 22, and spline teeth 36 as second spline teeth are formed on an outer circumferential surface of the second sleeve 26 to be engaged with the spline teeth 35.

In addition, dog teeth 37 as second dog teeth are formed on a leading end of an inner circumferential surface of the second sleeve 26 to be engaged with the dog teeth 28. Thus, the second sleeve 26 is always rotated integrally with the first ring gear 7, and allowed to reciprocate in the axial direction relatively to the first ring gear 7. That is, when the second sleeve 26 moves toward the front planetary gear unit 2 so that the dog teeth 37 is engaged with the dog teeth 28, the first ring gear 7 is connected to the first carrier 9 through the second sleeve 26.

By connecting the first carrier 9 to the second carrier 16 through the first clutch 4, the power transmission unit 1 is allowed to serve as a complex planetary gear mechanism to perform a differential action among the first carrier 9 connected to the second carrier 16, the second sun gear 13, and the first ring gear 7. Whereas, by connecting the first carrier 9 to the first ring gear 7 through the second clutch 5, the power transmission unit 1 is allowed to perform a differential action among the second carrier 16, the second sun gear 13, and the first ring gear 7. When both of the first carrier 9 and the second clutch 5 are connected to the first carrier 9, all of the power transmission unit 1 are rotated integrally. By contrast, when both of the first carrier 9 and the second clutch 5 are disconnected from the first carrier 9, a torque transmission among the second carrier 16, the second sun gear 13, and the first ring gear 7 is interrupted.

For example, the power transmission unit 1 may be arranged in a vehicle between a prime mover and drive wheels. In this case, the carrier shaft 21 is connected to an engine, the sun gear shaft 20 is connected to a motor that establishes a reaction force, and the outer teeth 23 are connected to the drive wheels through a gear train.

The vehicle in which the power transmission unit 1 is arranged is propelled in a low mode by engaging the dog teeth 33 of the first clutch 4 with the dog teeth 30 while establishing a reaction torque by the motor. In the low mode, specifically, a torque generated by the engine is distributed to the motor and the drive wheels, and the torque delivered to the drive wheels is relatively larger. By contrast, the vehicle in which the power transmission unit 1 is arranged is propelled in a high mode in which the torque delivered to the drive wheels is relatively smaller, by engaging the dog teeth 37 of the second clutch 5 with the dog teeth 28 while establishing a reaction torque by the motor. Further, the vehicle in which the power transmission unit 1 is arranged is propelled in a fixed mode in which the torque of the engine is delivered to the drive wheels without being changed, by engaging the dog teeth 33 of the first clutch 4 with the dog teeth 30 and engaging the dog teeth 37 of the second clutch 5 with the dog teeth 28 without establishing a reaction torque by the motor. By contrast, the vehicle in which the power transmission unit 1 is arranged is propelled in a disconnecting mode in which a torque transmission between the engine and the drive wheels is interrupted by disengaging the dog teeth 33 of the first clutch 4 from the dog teeth 30 and disengaging the dog teeth 37 of the second clutch 5 from the dog teeth 28. Thus, the torque transmission path in the power transmission unit 1 and a ratio between an input torque and an output torque to/from the power transmission unit 1 may be changed by manipulating the first clutch 4 and the second clutch 5.

The power transmission unit 1 may also be mounted in an electric vehicle having a drive motor as a prime mover. In this case, the carrier shaft 21 is provided with a brake, the sun gear shaft 20 or the carrier shaft 21 is connected to the drive motor, and the sun gear shaft 20 is provided with a brake.

Thus, according to the example shown in FIG. 1, the spline teeth 36 are formed on the outer circumferential surface of the second sleeve 26 and the dog teeth 37 are formed on the inner circumferential surface of the second sleeve 26. That is, the spline teeth 36 and the dog teeth 37 overlap with each other in the axial direction of the second sleeve 26. According to the example shown in FIG. 1, therefore, an axial length of the second sleeve 26 may be shortened. In addition, the first sleeve 24 is inserted radially inside the second sleeve 26. Therefore, when engaging the dog teeth 33 of the first clutch 4 with the dog teeth 30, the rear end of the first sleeve 24 is positioned in the rear side of the rear end of the second sleeve 26 in which the dog teeth 37 is disengaged from the dog teeth 28. That is, the axial length of the first sleeve 24 is elongated inevitably. In the power transmission unit 1 shown in FIG. 1, therefore, the spline teeth 34 and the dog teeth 33 are formed in tandem on the inner circumferential surface of the first sleeve 24. For this reason, an outer diameter of the first sleeve 24 will not be increased. In other words, the outer diameter of the first sleeve 24 is reduced so that an outer diameter of the second sleeve 26 will not be increased. Thus, not only the axial length but also the outer diameter of the power transmission unit 1 can be reduced.

Further, none of spline teeth and dog teeth are formed on the outer circumferential surface of the first sleeve 24. In the power transmission unit 1 shown in FIG. 1, therefore, a thickness of the first sleeve 24 can be increased. For this reason, dimensions of the first sleeve 24 will not be varied even if the first sleeve 24 is subjected to a quenching to increase hardness thereof.

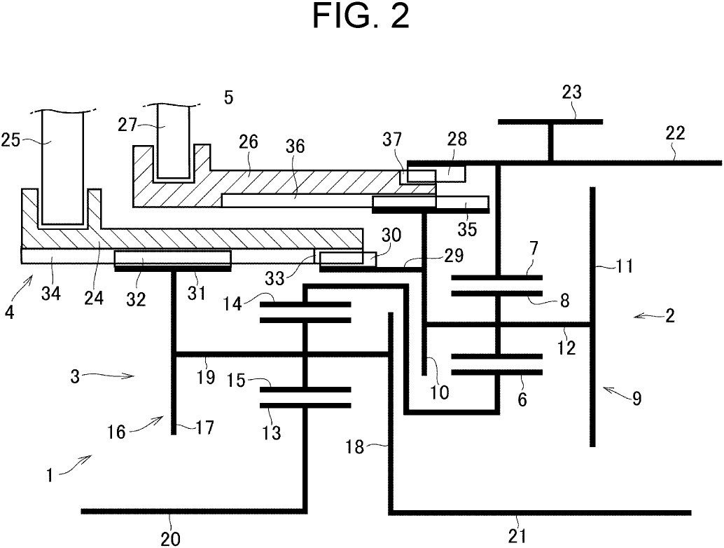

Although the above exemplary embodiments of the present disclosure have been described, it will be understood by those skilled in the art that the present disclosure should not be limited to the described exemplary embodiments, and various changes and modifications can be made within the scope of the present disclosure. As described, the axial length of the second sleeve 26 is reduced by forming the spline teeth 36 on the outer circumferential surface thereof and forming the dog teeth on the inner circumferential surface thereof. Whereas, in the power transmission unit according to another example shown in FIG. 2, the dog teeth 37 are formed on the outer circumferential surface of the second sleeve 26, the spline teeth 36 are formed on the inner circumferential surface of the second sleeve 26, the spline teeth 35 are formed on the outer circumferential surface of the rear carrier plate 10 to be engaged with the spline teeth 36 of the second sleeve 26, and the dog teeth 28 are formed on the inner circumferential surface of the cylindrical shaft 22 to be engaged with the dog teeth 37 of the second sleeve 26.

In addition, in the power transmission unit, two pairs of rotary members may be arranged coaxially instead of the rotary elements of the planetary gear units. In this case, a radius of an engagement site between one of the pairs of the rotary members is smaller than a radius of an engagement site between the other one of the pairs of the rotary members, and sleeves of engagement devices are reciprocated in the axial direction to selectively engage the pair of rotary members.

What is claimed is:

1. A power transmission unit, comprising:
a first engagement device that selectively connects a predetermined pair of rotary members to each other; and
a second engagement device that selectively connects another pair of rotary members to each other,
wherein the first engagement device comprises a cylindrical first sleeve that reciprocates in an axial direction,
the second engagement device comprises a cylindrical second sleeve that reciprocates in the axial direction,
the first sleeve is inserted into the second sleeve at least partially,
first spline teeth engaged with any one of the predetermined pair of rotary members and first dog teeth engaged with the other one of the predetermined pair of rotary members are formed on an inner circumferential surface of the first sleeve,
second spline teeth engaged with any one of the another pair of rotary members are formed on any one of an inner circumferential surface and an outer circumferential surface of the second sleeve, and
second dog teeth engaged with the other one of the another pair of rotary members are formed on the other one of the inner circumferential surface and the outer circumferential surface of the second sleeve.

2. The power transmission unit as claimed in claim 1,
wherein the predetermined pair of rotary members includes a first rotary member and a second rotary member, and
the another pair of rotary members includes the first rotary member and a third rotary member.

3. The power transmission unit as claimed in claim 2,
wherein a first engagement section is formed on an outer circumferential surface of the first rotary member to be engaged with the second spline teeth or the second dog teeth,
a cylindrical shaft extends on a radially inner side of the first engagement section, and
a second engagement section is formed on the cylindrical shaft to be engaged with the first spline teeth or the first dog teeth.

4. The power transmission unit as claimed in claim 1, further comprising:
a first differential mechanism in which a first rotary element, a second rotary element, and a third rotary element are connected to one another in a differential manner,
wherein the another pair of rotary members includes: any one of the first rotary element, the second rotary element, and the third rotary element; and another one of the first rotary element, the second rotary element, and the third rotary element.

5. The power transmission unit as claimed in claim 4,
wherein the first differential mechanism comprises a sun gear, a ring gear, and a carrier, and
the another one of the first rotary element, the second rotary element, and the third rotary element includes the carrier.

6. The power transmission unit as claimed in claim 4, further comprising:
a second differential mechanism in which a fourth rotary element, a fifth rotary element, and a sixth rotary element are connected to one another in a differential manner,
wherein the predetermined pair of rotary members includes: any one of the fourth rotary element, the fifth rotary element, and the sixth rotary element; and the another one of the first rotary element, the second rotary element, and the third rotary element.

7. The power transmission unit as claimed in claim 5, further comprising:
a second differential mechanism in which a fourth rotary element, a fifth rotary element, and a sixth rotary element are connected to one another in a differential manner,
wherein the predetermined pair of rotary members includes: any one of the fourth rotary element, the fifth rotary element, and the sixth rotary element; and the another one of the first rotary element, the second rotary element, and the third rotary element.

8. The power transmission unit as claimed in claim 6,
wherein the carrier comprises a pair of carrier plates opposed to each other in the axial direction,
a third engagement section is formed on an outer circumferential surface of one of the carrier plates to be engaged with the second spline teeth or the second dog teeth,
a cylindrical shaft extends on radially inner side of the third engagement section, and
a fourth engagement section is formed on the cylindrical shaft to be engaged with the first spline teeth or the first dog teeth.

9. The power transmission unit as claimed in claim 7,
wherein the carrier comprises a pair of carrier plates opposed to each other in the axial direction,
a third engagement section is formed on an outer circumferential surface of one of the carrier plates to be engaged with the second spline teeth or the second dog teeth,
a cylindrical shaft extends on radially inner side of the third engagement section, and
a fourth engagement section is formed on the cylindrical shaft to be engaged with the first spline teeth or the first dog teeth.

10. The power transmission unit as claimed in claim 8,
wherein an inner diameter of the cylindrical shaft is larger than an outer diameter of the second differential mechanism,
the second differential mechanism is arranged inside the cylindrical shaft, and
the fourth engagement section is formed coaxially with the second differential mechanism.

11. The power transmission unit as claimed in claim 9,
wherein an inner diameter of the cylindrical shaft is larger than an outer diameter of the second differential mechanism,
the second differential mechanism is arranged inside the cylindrical shaft, and
the fourth engagement section is formed coaxially with the second differential mechanism.
